(19) United States
(12) Patent Application Publication
(10) Pub. No.: US 2013/0185209 A1
(43) Pub. Date: Jul. 18, 2013

(54) TRANSACTION-BASED ONE TIME PASSWORD (OTP) PAYMENT SYSTEM

(71) Applicant: Tae Hoon AHN, Seoul (KR)

(72) Inventor: Tae Hoon AHN, Seoul (KR)

(73) Assignee: LG CNS CO., LTD., Seoul (KR)

(21) Appl. No.: 13/555,442

(22) Filed: Jul. 23, 2012

(30) Foreign Application Priority Data
Jan. 12, 2012 (KR) 10-2012-0003976

(51) Int. Cl. G06Q 20/38

(52) U.S. Cl. CPC G06Q 20/3827
USPC 705/44

(57) ABSTRACT

Embodiments of the present invention provide a payment processing system. Specifically, a mobile client generates a request for payment of a payment transaction. The mobile client generates a one-time value associated with the payment transaction. The one-time value is a first hash value. The transaction information is received at an authorizing device. The authorizing device generates confirmation information and transmits the confirmation information to the mobile client. The authorizing device generates a second hash value based on the confirmation information. The request for payment is approved when the first hash value matches the second hash value.

### CROSS-REFERENCE TO RELATED APPLICATIONS

This application is based on and claims priority from Korean Patent Application No. 10-2012-0003976, filed on Jan. 12, 2012, with the Korean Intellectual Property Office, the present disclosure of which is incorporated herein in its entirety by reference.

### TECHNICAL FIELD

In general, embodiments of the present invention relate to an electronic payment system and more particularly to a transaction-based one time password (OTP) payment system.

### BACKGROUND

During the late 1980s and early 1990s, approximately sixty percent of the fraud reported by financial institutions related to bank insider abuse. Since that time, external fraud schemes have replaced bank insider abuse as the dominant financial institution fraud problem confronting financial institutions. The pervasiveness of check fraud and counterfeit negotiable instrument schemes, technological advances, as well as the availability of personal information through information networks, has fueled the growth in external fraud.

Several types of schemes have been used by criminals to perpetrate a fraud. The “over the shoulder looking” scheme occurs when a customer performs payment transactions while being observed by a criminal. A fair number of cases have been reported where customer's account access data was obtained by the criminal just by observing customers at a public Internet access point.

The “phishing” scheme involves using fake emails and/or fake websites. The word “phishing” stems from combining the words “password” and “fishing”. Criminals send emails that appear to be from the customer's financial institution that direct customers to a fake website. This website impersonates the financial institution's website and prompts customers for their account access data. Over the past months, most financial institutions have executed customer education programs, thereby reducing the effectiveness of this scheme. It will, however, take a while before all customers are smart enough to extinct phishing.

The “Trojan horse” scheme is based on embedding a computer virus type software program onto the customer's personal computer (PC). Trojans often tie themselves into the keyboard driver and record keystrokes. Once a Trojan detects that the customer opens an online website of a financial institution, it captures login name and password, and sends it to the criminal.

In an effort to improve security, some financial institutions now use “one time passwords”, also called OTP. Upon activation of the customer's account, the financial institution mails a list of OTPs to the customer. Each time the customer performs a transaction, he enters one OTP for verification. Once used, the OTP becomes invalid. If the customer runs out of OTPs, he is sent a new list. While this approach effectively prevents “over the shoulder looking”, it generally fails to prevent other fraud schemes. Phishing emails also ask for OTPs, and a customer naive enough to give out his logon name and password will likely also provide OTPs. Trojans simply also capture the OTP once entered. At the same time, they falsify the customer's input in the browser software (e.g. by adding an invisible character) or cause the browser software to crash. This causes the customer's transaction to be intercepted and the OTP to still be valid. The criminal can then use this valid OTP to perform a fraudulent transaction.

The shortcoming of paper OTP lists lies in the fact that each OTP is not transaction specific. That is, the same OTP can be used to verify either a genuine or a fraudulent transaction. In current implementations of transaction-based OTP systems, off-line authentication requires near field communication (NFC) devices in the stores or the use of a mobile phone device. When the mobile client is used for the authorization, the finance industry uses a secure key in the application. When a finance company changes the system, it causes the problem for copying the application security code. This method is also susceptible to the hackers. Heretofore, several unsuccessful attempts have been made to address these shortcomings.

U.S. Patent Application 20080103984 discloses a system and method for user authentication and mobile payment authorization in which a user operating a mobile terminal submits a product for purchase at a point of sale along with the user's phone number and personal identification number.

U.S. Patent Application 20110060913 discloses a system and method for generating a one-time passcode (OTP) from a user device.

U.S. Patent Application 20110113245 discloses a system for generating a one-time passcode (OTP) configured for use as a personal identification number (PIN) for a user account from a user device.

U.S. Patent Application 20100106649 discloses a system and method for authorizing transactions via mobile clients in which a transaction authorization application generates a transaction code for a transaction upon request by a user.

U.S. Patent Application 20110258121 discloses an approach for conducting transactions via an audio token base payment system.

None of these references, however, teach an on-line approval system using one-time password (OTP) allowance authentication in payment processing.

### SUMMARY

In general, embodiments of the present invention provide a payment processing system. Specifically, a mobile client generates a request for payment of a payment transaction. The mobile client generates a one-time value associated with the payment transaction. The one-time value is a first hash value. The transaction information is received at an authorizing device. The authorizing device generates confirmation information and transmits the confirmation information to the mobile client. The authorizing device generates a second hash value based on the confirmation information. The request for payment is approved when the first hash value matches the second hash value.

A first aspect of the present invention provides a payment processing system, the system comprising: a mobile client configured to generate a request for a payment associated with a payment transaction; the mobile client further configured to generate a one-time value associated with the payment transaction, wherein the one-time value is a first hash value; an authorizing device configured to receive transaction information associated with the payment transaction and transmit confirmation information to the mobile client; and the authorizing device further configured to generate a second hash value, wherein the first hash value and the second hash value are based on the confirmation information.

A second aspect of the present invention provides a computer-implemented method for processing a payment transaction, comprising: generating a request for a payment associated with a payment transaction at a mobile client; generating a one-time value associated with the payment transaction at the mobile client, wherein the one-time value is a first hash value; receiving transaction information associated with the payment transaction at an authorizing device; receiving confirmation information at the authorizing device; transmitting the confirmation information to the mobile client; and generating a second hash value at the authorizing device, wherein the first hash value and the second hash value are based on the confirmation information.

A third aspect of the present invention provides a computer program product comprising a computer-readable storage medium; and instructions in the computer-readable storage medium, wherein the instructions, when executed in a mobile client, cause the mobile client to perform operations comprising: generating a request for a payment associated with a payment transaction; generating a one-time value associated with the payment transaction, wherein the one-time value is a first hash value; transmitting transaction information associated with the payment transaction to an authorizing device; and receiving confirmation information from the authorizing device.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative payment processing environment in which various aspects of the invention may be implemented.

FIG. 2 depicts a graphical illustration of an online payment process according to an embodiment of the present invention.

FIG. 3 depicts a method flow diagram for payment processing according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As mentioned above, embodiments of the present invention provide a payment processing system. Specifically, a mobile client generates a request for payment of a payment transaction. The mobile client generates a one-time value associated with the payment transaction. The one-time value is a first hash value. The transaction information is received at an authorizing device. The authorizing device generates confirmation information and transmits the confirmation information to the mobile client. The authorizing device generates a second hash value based on the confirmation information. The request for payment is approved when the first hash value matches the second hash value.

The advent of mobile communication networks has opened many new mechanisms for cashless payments for products and services using personal wireless devices. Products purchased with mobile payments have become diverse, ranging from mobile contents to vending machine items. Equally diverse are the mobile payment methods owing to the relatively new payment system that can be implemented in many different ways. One common step in these methods of mobile payment is the authentication and authorization in which all users who wish to make a payment via a mobile client must be authenticated such that the merchant will receive the authorization to proceed with the sale.

In some existing payment systems, the user makes a purchase at the point-of-sale (POS) terminal or website, and the POS sends a message including information associated with the user to the payment system for authentication. The payment system then verifies the account user and proceeds to authorize the purchase.

The present invention provides an on-line transaction approval system. The system may provide one-time password allowance authentication, and is able to use trusted third party information. The system is described in detail below.

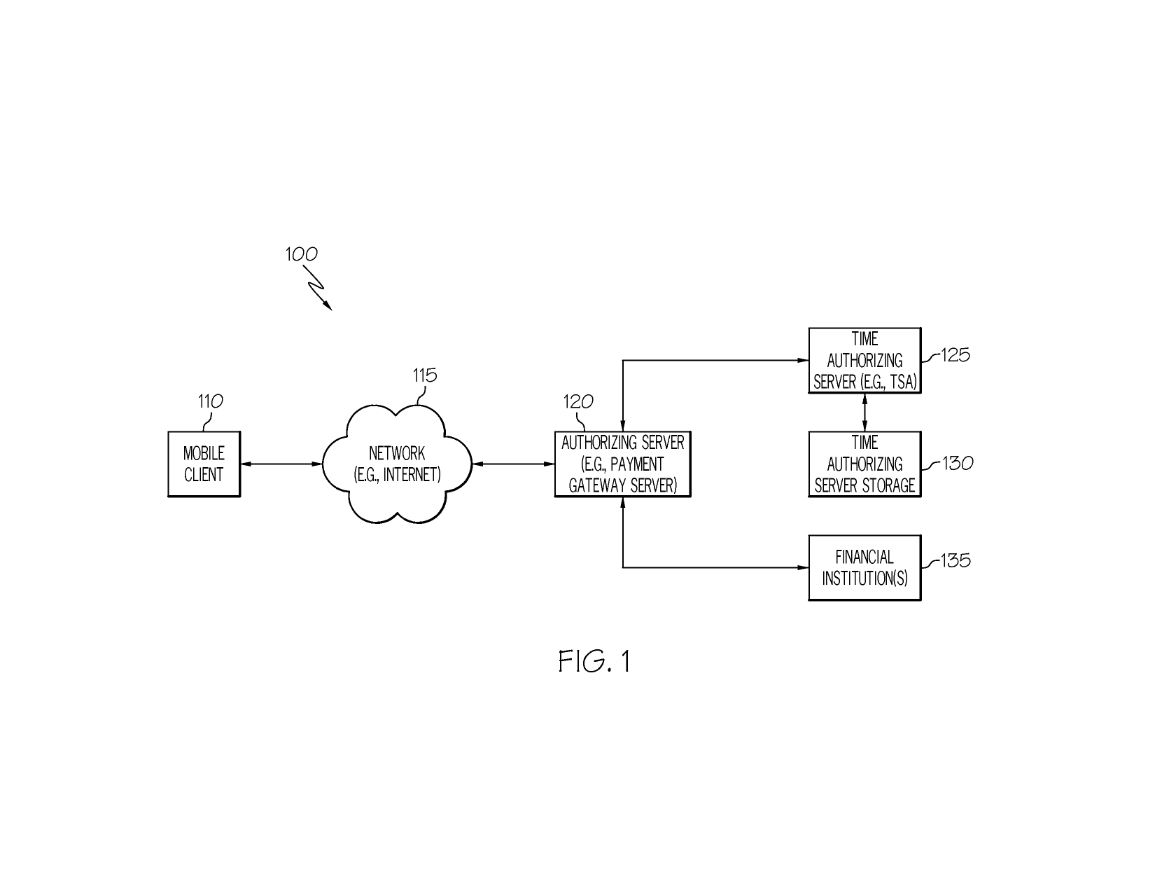

FIG. 1 shows an illustrative payment processing environment 100 in which various aspects of the invention may be implemented. The payment processing environment 100 is only one example of a suitable environment and is not intended to suggest any limitation as to the scope of use or functionality of the invention. The payment processing environment 100 should not be interpreted as having any dependency or requirement relating to any one or combination of components shown in the illustrative payment processing environment 100.

With reference to FIG. 1, the payment processing environment 100 may include a mobile client 110, network 115, authorizing server 120, time authorizing server 125, time authorizing server storage 130, and one or more financial institutions 135.

Mobile client 110 may include any wireless device, such as a cell phone or personal digital assistant. In addition, such mobile client 110 is also intended to include a mobile personal computer, such as a laptop computer. A mobile client application may operate on the mobile client 110. The mobile client application supports graphic intensive content and is device independent so that it can operate on a variety of different mobile clients.

One of ordinary skill in the art will appreciate that network 115 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile client 110 and authorizing server 120.

In one example, communication network 115 may be a part of the world-wide web (i.e., the Internet). The Internet, in a well-known manner, connects millions of computers world-wide through standard common addressing systems and communications protocols (e.g., Transmission Control Protocol/Internet Protocol (TCP/IP), HyperText Transport Protocol) creating a vast communications network.

The authorizing server 120 may perform a settlement (e.g., an electronic payment service), based on a payment transaction between the mobile client 110 and a store in cooperation with a financial institution 135. In one example, the authorizing server 120 may be a payment gateway (PG) server. The electronic payment service is an essential feature in the electronic commerce market, and electronic payment is generally made through several types of services including credit card payment, mobile phone payment, phone billing, transfer account, and so on. Some companies provide all of these payment services, called integrated electronic payment services. However, most payment gateway companies provide themselves with only one or two types of payment services and usually cooperate with other payment companies to thus complement electronic payment services.

The time authorizing server 125 may provide a time code that the authorization approval of a payment transaction is completed. In one example, a transaction security authority (TSA) organization may control the authorization request. The time authorizing server 125 may store payment information related to a payment transaction in the time authorizing server storage 130.

A user may have an account at one or more financial institutions 130. Information related to a payment transaction is transmitted to the respective financial institution in order to authorize the transaction. Example financial institutions 130 may include, but are not limited to, a credit card company, a bank, a telephone company, and the like.

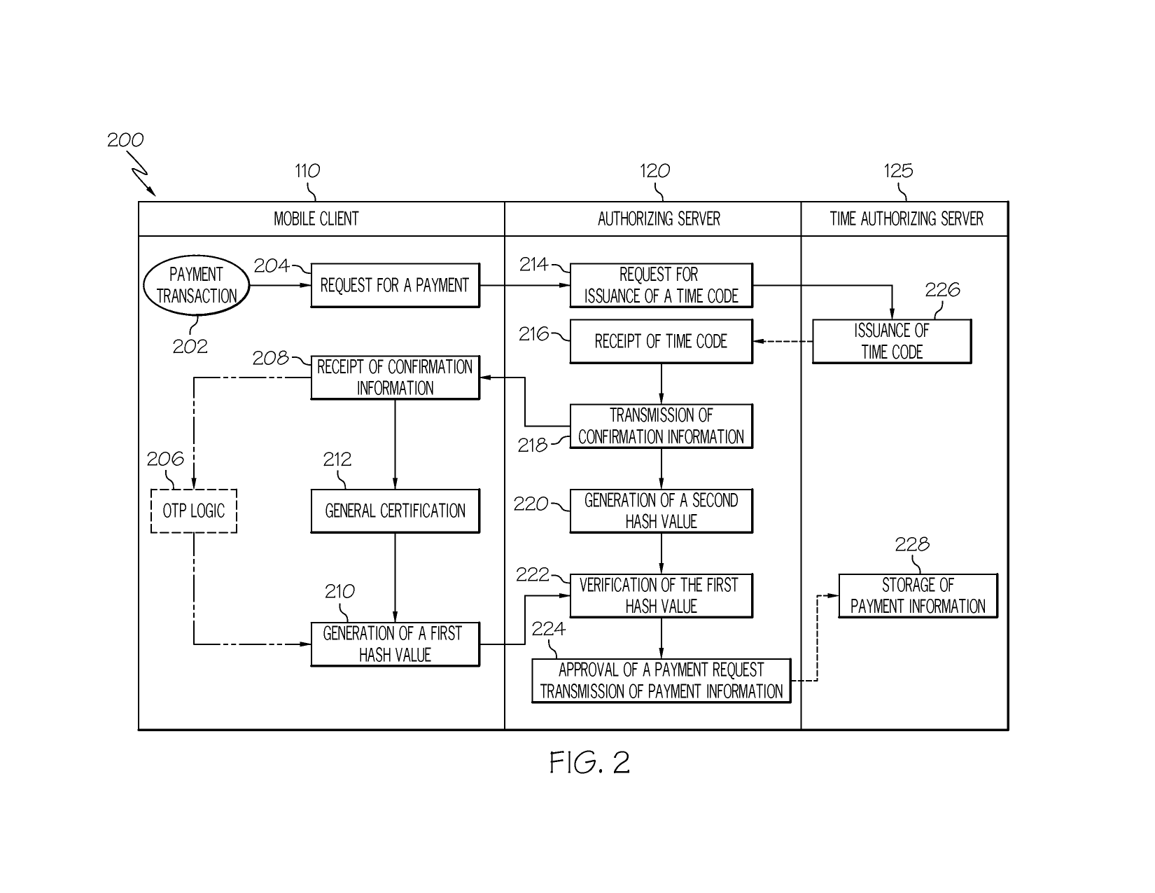

Referring now to FIG. 2, a high-level graphical illustration of an online payment process environment 200 according to an embodiment of the present invention is shown. The online payment process environment 200 may include mobile client 110, authorizing server 120, and time authorizing server 125.

The user may wish to make a payment transaction (202) at an end user service point (not shown). The user end service point may comprise a web mall (i.e., web-based purchasing), an order via call (i.e., phone-based purchasing) and/or a point of sale (POS). POS or checkout is a location where a transaction occurs. A “checkout” refers to a POS terminal or more generally to the hardware and software used for checkouts, the equivalent of an electronic cash register.

When the user (i.e., customer) attempts to make a purchase, the mobile client 110 may send a request for payment 204 to the authorizing server 120. Upon receiving the request for payment, the authorizing server 120 may send a request for issuance of a time code 226 to the time authorizing server 125. The time code represents the time that the authorization approval is completed. The time code may be received 216 at the authorizing server 120. The authorizing server 120 may transmit confirmation information 218 to the mobile client 110. In one example, the confirmation information may include transaction amount, transaction method, card number, transaction time, device ID and transaction location and may be stored at the authorizing server 120. The confirmation information may be received 208 at the mobile client 110. The mobile 110 client may generate a general certification 212. In other words, the mobile client 110 may send a certificate request using a unique key value associated with the user (e.g., public key) to a certification authority to verify the identity of the user.

Using a one-time password (OTP) algorithm, the mobile client 110 may generate a first hash value 210 based on the confirmation information. The authorizing server 120 may generate a second hash value 220 based on the confirmation information. The second hash value may be used to test the authentication of the first hash value. The authorizing server 120 may receive the first hash value from the mobile client 110. The first hash value and the second hash value may be compared at the authorizing server 120 for verification of the first hash value 222. The hash logic used in the hash value evaluation may include a shuffling method or a rainbow table. If the first hash value matches the second hash value, the payment request may be approved and payment information may be transmitted 224 to the time authorizing server 125. The payment information may be stored 228 at time authorizing server storage 130.

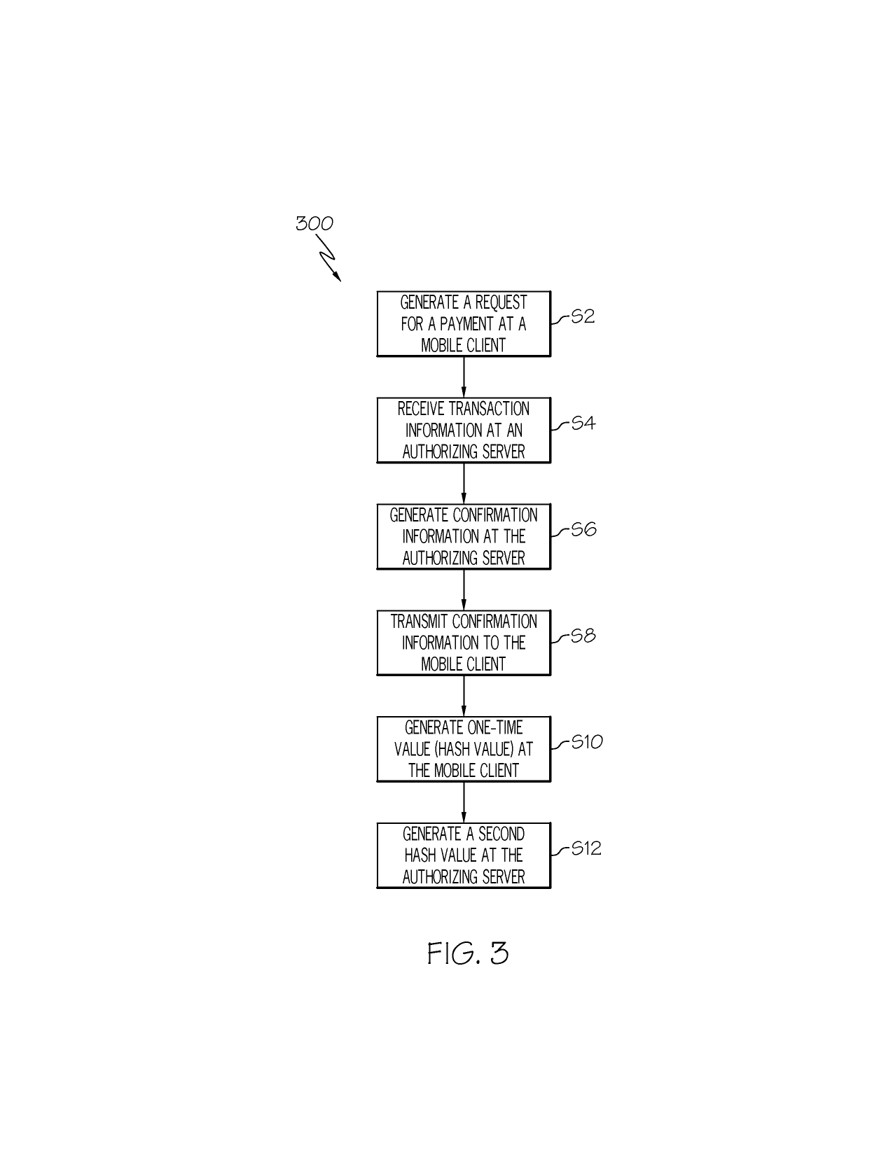

Referring now to FIG. 3, a method flow diagram for payment processing according to an embodiment of the present invention is shown. At S2, a request for a payment of a payment transaction may be generated at a mobile client. At S4, transaction information may be received at an authorizing server. At S6, confirmation information may be generated at the authorizing server based on the transaction information. At S8, the confirmation information may be transmitted to the mobile client. At S10, a one-time value (i.e., first hash value) may be generated at the mobile client. At S12, a second hash value is generated at the authorizing server based on the confirmation information.

It should be noted that, in some alternative implementations, the functions noted in the blocks may occur out of the order noted in FIG. 3. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

While shown and described herein as a payment authorization solution, it is understood that the invention further provides various alternative embodiments. For example, in one embodiment, the invention provides a computer-readable/useable medium that includes computer program code to enable a computer infrastructure to provide payment authorization functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.).

In another embodiment, the invention provides a computer-implemented method for payment authorization. In this case, a computer infrastructure can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A payment processing system, the system comprising:
a mobile client configured to generate a request for a payment associated with a payment transaction;
the mobile client further configured to generate a one-time value associated with the payment transaction, wherein the one-time value is a first hash value;
an authorizing device configured to receive transaction information associated with the payment transaction and transmit confirmation information to the mobile client; and
the authorizing device further configured to generate a second hash value, wherein the first hash value and the second hash value are based on the confirmation information.

2. The payment processing system of claim 1, further comprising approving the request for the payment when the first hash value matches the second hash value.

3. The payment processing system of claim 2, wherein the authorizing device generates a request for issuance of a code relating to the time of the request for the payment from the mobile client.

4. The payment processing system of claim 3, further comprising receiving the code from a time authorizing device.

5. The payment processing system of claim 1, wherein the transaction information comprises at least one of an amount, an authorizing method, an identification number identifying the place of purchase, or a time of purchase.

6. The payment processing system of claim 1, wherein the first value is a password.

7. The payment processing system of claim 1, wherein the authorizing device is a payment gateway (PG) server.

8. The payment processing system of claim 1, wherein the mobile client is further configured to send a certificate request to a certification authority prior to generating the first hash value.

9. A computer-implemented method for processing a payment transaction, comprising:
generating a request for a payment associated with a payment transaction at a mobile client;
generating a one-time value associated with the payment transaction at the mobile client, wherein the one-time value is a first hash value;
receiving transaction information associated with the payment transaction at an authorizing device;
receiving confirmation information at the authorizing device;
transmitting the confirmation information to the mobile client; and
generating a second hash value at the authorizing device, wherein the first hash value and the second hash value are based on the confirmation information.

10. The computer-implemented method of claim 9, further comprising approving the request for the payment when the first hash value matches the second hash value.

11. The computer-implemented method of claim 10, further comprising generating a request for issuance of a code at the authorizing device relating to the time of the request for the payment from the mobile client.

12. The computer-implemented method of claim 11, further comprising receiving the code from a time authorizing device.

13. The computer-implemented method of claim 9, wherein the transaction information comprises at least one of an amount, an authorizing method, an identification number identifying the place of purchase, or a time of purchase.

14. The computer-implemented method of claim 9, wherein the first value is a password.

15. The computer implemented-method of claim 9, wherein the authorizing device is a payment gateway (PG) server.

16. The computer-implemented method of claim 9, further comprising sending a certificate request to a certification authority from the mobile client prior to generating the first hash value.

17. A computer program product comprising a computer-readable storage medium; and instructions in the computer-readable storage medium, wherein the instructions, when executed in a mobile client, cause the mobile client to perform operations comprising:
generating a request for a payment associated with a payment transaction;
generating a one-time value associated with the payment transaction, wherein the one-time value is a first hash value;
transmitting transaction information associated with the payment transaction to an authorizing device; and
receiving confirmation information from the authorizing device.

18. The computer program product of claim 17, wherein the request for the payment is approved when the first hash value matches a second hash value generated at the authorizing device, wherein the first hash value and the second hash value are based on the confirmation information.

19. The computer program product of claim 18, wherein the instructions further cause the mobile client to perform operations comprising: receiving a code from a time authorizing device, wherein the code is generated based on a request for issuance of the code at the authorizing device relating to the time of the request for the payment from the mobile client.

20. The computer program product of claim 17, wherein the transaction information comprises at least one of an amount, an authorizing method, an identification number identifying the place of purchase, or a time of purchase.

21. The computer program product of claim 17, wherein the first value is a password.

22. The computer program product of claim 17, wherein the authorizing device is a payment gateway (PG) server.

23. The computer program product of claim 17, wherein the instructions further cause the mobile client to perform operations comprising sending a certificate request to a certification authority prior to generating the first hash value.
